(19) United States
(12) Patent Application Publication
(10) Pub. No.: US 2014/0363039 A1
(43) Pub. Date: Dec. 11, 2014

(54) PROTECTIVE CASE WITH SPEAKERPHONE FOR DIGITAL PRODUCTS

(71) Applicant: Li Zanxiang, Shenzhen (CN)

(72) Inventor: Li Zanxiang, Shenzhen (CN)

(21) Appl. No.: 14/016,701

(22) Filed: Sep. 3, 2013

(30) Foreign Application Priority Data
Jun. 9, 2013 (CN) 201320335105.3

(51) Int. Cl. H04R 1/02

(52) U.S. Cl. CPC H04R 1/021
USPC 381/334

(57) ABSTRACT

A digital product protective cover with speakerphone, including a protective cover main body where the main body includes a bottom board and surrounding curved walls, at least one card slot located between the bottom board and curved walls, where each card slot is inter-connected, each card slot includes at least one amplification mechanism, the amplification mechanism includes a sound inlet, a sound outlet, and a sound tube, which connects the sound inlet and sound outlet. The sound inlet is located at the bottom of the card slot, which is in proximity to an external speaker of the digital product, the sound inlet and sound outlet are staggered in the longitudinal direction of the card slot, and the sound inlet and sound outlet are staggered in such a position to extend the length of the sound tube.

### CROSS-REFERENCE TO RELATED APPLICATIONS

This patent application claims the benefit under 35 U.S.C. §119(a) of Chinese Patent Application No. 201320335105.3, filed Jun. 9, 2013, which application is incorporated herein by reference.

### FIELD OF THE INVENTION

The invention broadly relates to a protective case, more specifically to a protective case with a speakerphone, and even more particularly to a protective case with a speakerphone for digital products.

### BACKGROUND OF THE INVENTION

With the development of science and technology, a variety of digital products have entered into people's working lives. In order to protect these digital products from damage, people equip their digital products with protective cases. However, existing cases are not strong enough when the digital product accidentally drops to provide adequate protection. Moreover, existing cases and the speaker amplification effect is poor, resulting in a negative user experience.

As can be derived from the variety of devices and methods directed at protecting digital protects, many means have been contemplated to accomplish the desired end, i.e., securing a digital product with a protective case with a speakerphone. Heretofore, existing protective cases for digital products have not adequately provided the user with sufficient amplification in the speakerphone. Thus, there is a long-felt need for a protective case with a speakerphone for digital products.

### BRIEF SUMMARY OF THE INVENTION

The present invention broadly comprises a digital product protective cover with a speakerphone. The invention includes a protective cover main body, where the body includes a bottom board surrounded by curved walls. At least one card slot is formed between the bottom board and curved walls, where each card slot connected to each other. Each card slot has at least one amplification mechanism, where the amplification mechanism further includes a sound inlet, a sound outlet, and a sound tube that connects the sound inlet and sound outlet. The sound inlet is located at the bottom of the card slot, which is located against the external speaker of the digital product. The sound outlet is located on the outer wall of the card slot. The sound inlet and sound outlet are staggered in the longitudinal direction of the card slot.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a perspective view of a digital product protective cover with a speakerphone;

FIG. 2 is a cross-sectional view of the digital product protective cover with a speakerphone depicted in FIG. 1;

FIG. 3 is a side cross-sectional view of the digital product protective cover with a speakerphone depicted in FIG. 1;

FIG. 4 is a perspective view a second embodiment of the digital product protective cover with a speakerphone;

FIG. 5 is a cross-sectional view of the protective cover in FIG. 4;

FIG. 6 is a side cross-sectional view of the digital product protective cover with a speakerphone depicted in FIG. 4;

FIG. 7 is a perspective view a third embodiment of the digital product protective cover with a speakerphone;

FIG. 8 is a cross-sectional view of the protective cover in FIG. 7; and,

FIG. 9 is a side cross-sectional view of the digital product protective cover with a speakerphone depicted in FIG. 7.

### DETAILED DESCRIPTION OF THE INVENTION

At the outset, it should be appreciated that like drawing numbers on different drawing views identify identical, or functionally similar, structural elements of the invention.

While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. It should be appreciated that the term “cover” is synonymous with terms such as “case”, “holder”, “jacket”, etc., and such terms may be used interchangeably as appearing in the specification and claims. Although any methods, devices or materials similar or equivalent to those described herein can be used in the practice or testing of the invention, the preferred methods, devices, and materials are now described.

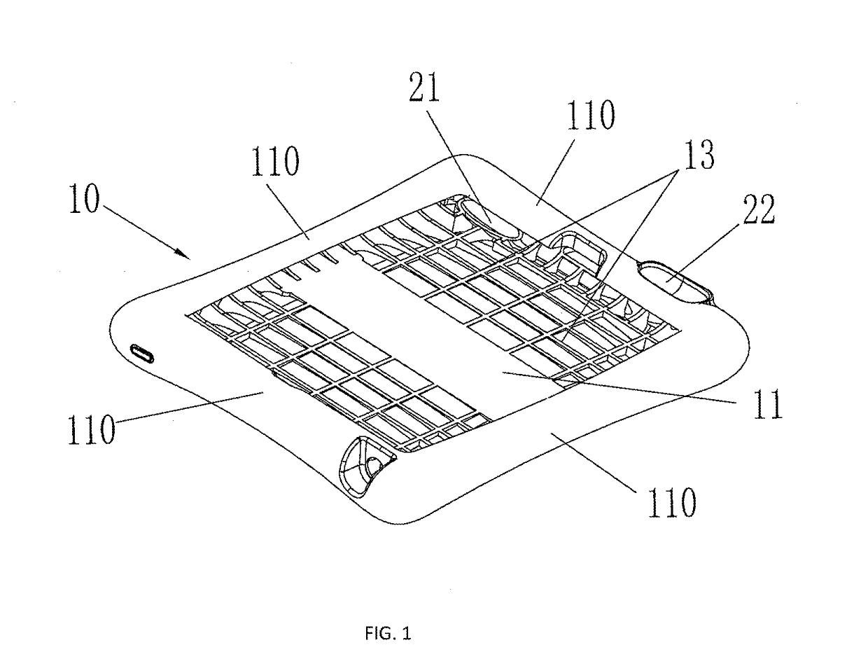

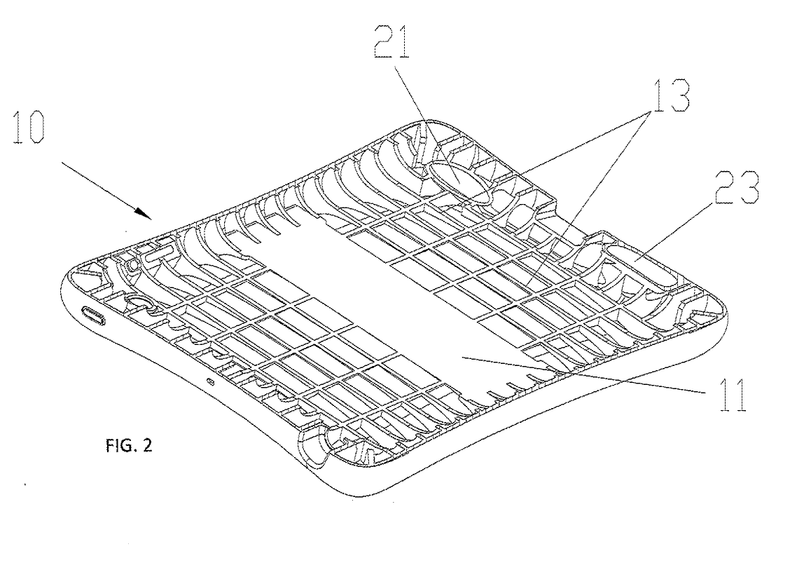

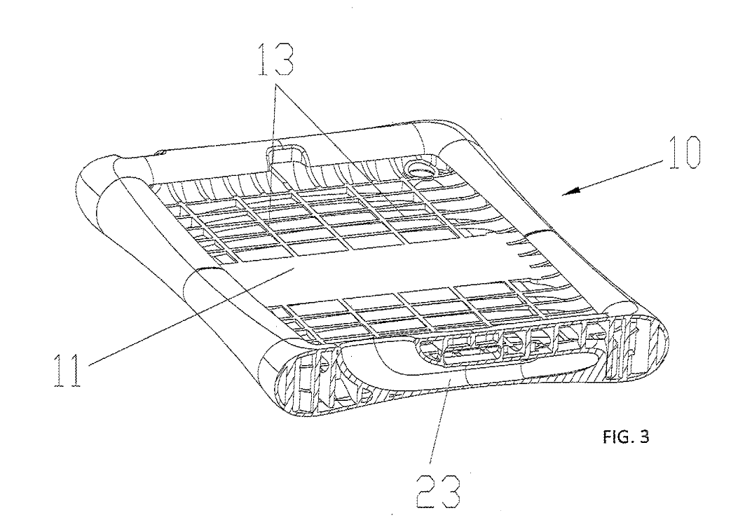

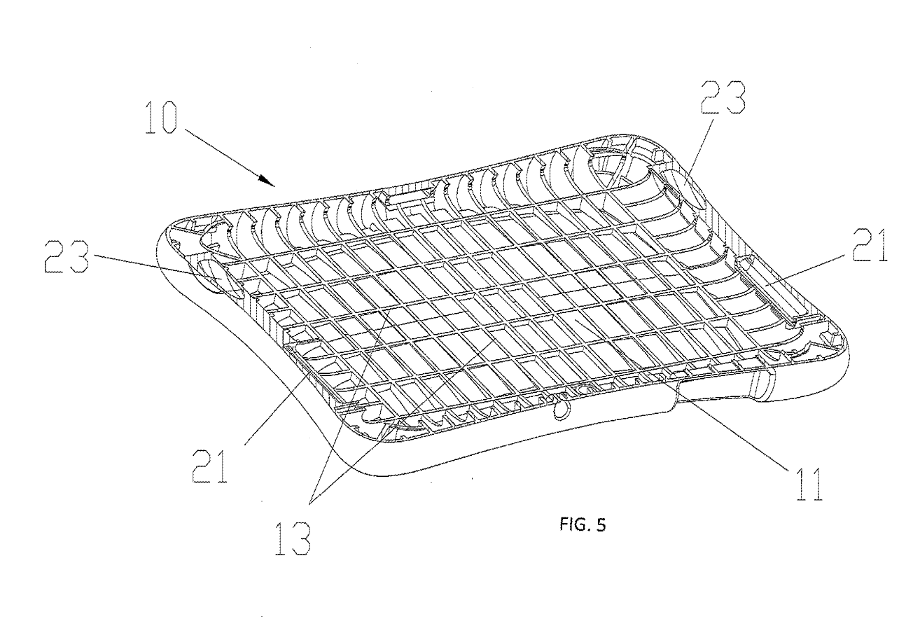

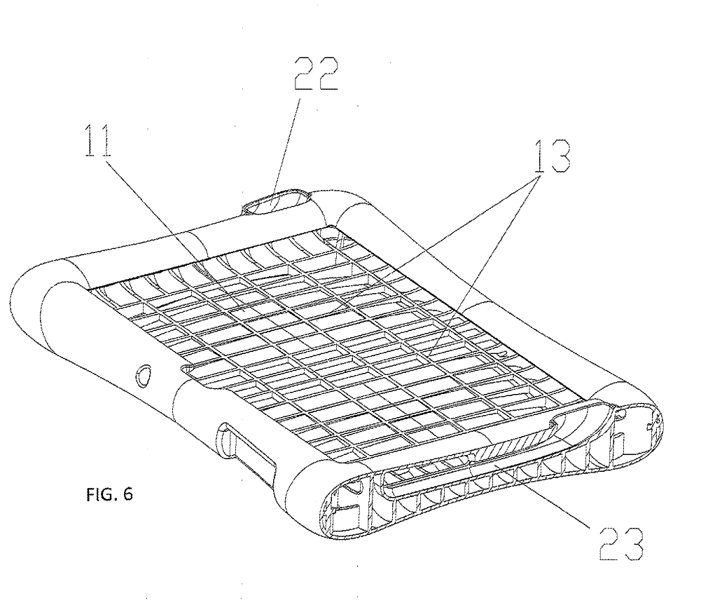

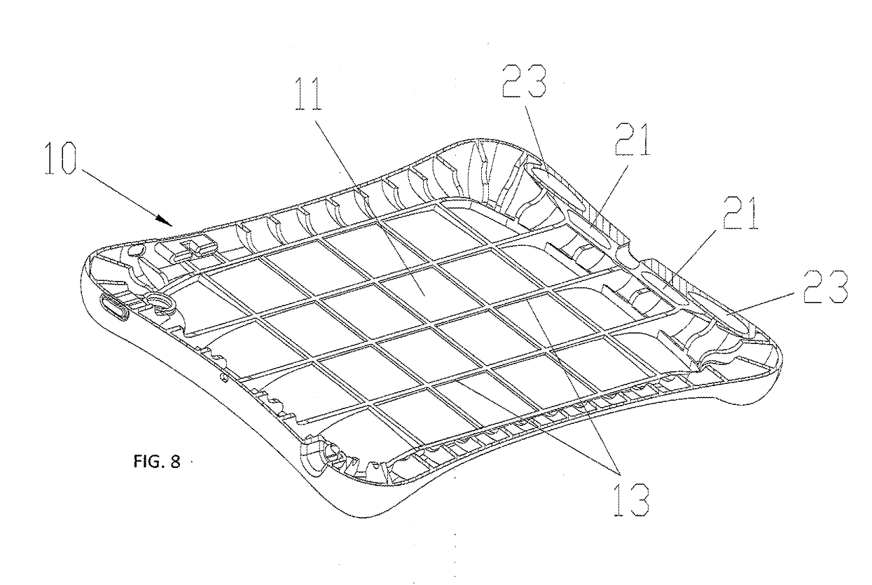

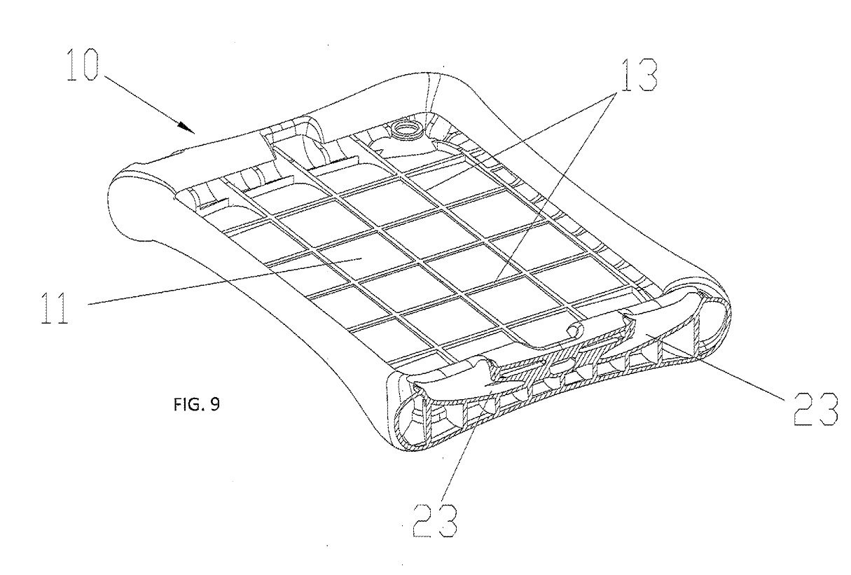

Adverting now to FIGS. 1 to 9, FIG. 1 shows a digital product protective cover with speakerphone, including protective cover main body 10, the body further including bottom board 11 and curved walls 110. Each card slot (not depicted) is formed between bottom board 11 and curved walls 110, where each card slot is connected to one other. Each card slot includes at least one amplification mechanism. The amplification mechanism further includes sound inlet 21, sound outlet 22, and sound tube 23, shown in FIG. 3, which connects the sound inlet and the sound outlet. Sound inlet 21 is located at the bottom of the card slot, which is located against the external speaker of the digital product. Sound outlet 22 is located on the outer wall of the card slot. Sound inlet 21 and sound outlet 22 are staggered in the longitudinal direction of the card slot.

The cross section of sound tube 23 gradually increases from sound inlet 21 to sound outlet 22. Bottom board 11 surface is includes reinforced ribs 13, each reinforced rib 13 extends to the internal surface of the card slot around bottom board 11.

When used, the frame of digital product fits in the card slot, so that the digital product is surrounded by the protective cover. External card slot sidewalls around the protective cover have a power supply interface, USB interface, and various avoidance gaps for the digital product control buttons. The setting of digital product protective cover is well known in the art.

Referring to FIGS. 1, 2, and 3, an example embodiment of the digital product protective cover with speakerphone is shown.

In this embodiment, sound inlet 21 and sound outlet 22 are located at both ends of the card slot, in particular, the amplification mechanism is set on the right side of the card slot. Sound inlet 21 is set beneath the upper card slot and sound outlet 22 is set on the outside wall of the lower card slot. Sound tube 23 is lays in the card slot. Thus, the sound signal from sound inlet 21 travels into sound tube 23. After transmission, sound tube 23 sends out the sound signal through sound outlet 22, thereby enhancing the sound signal.

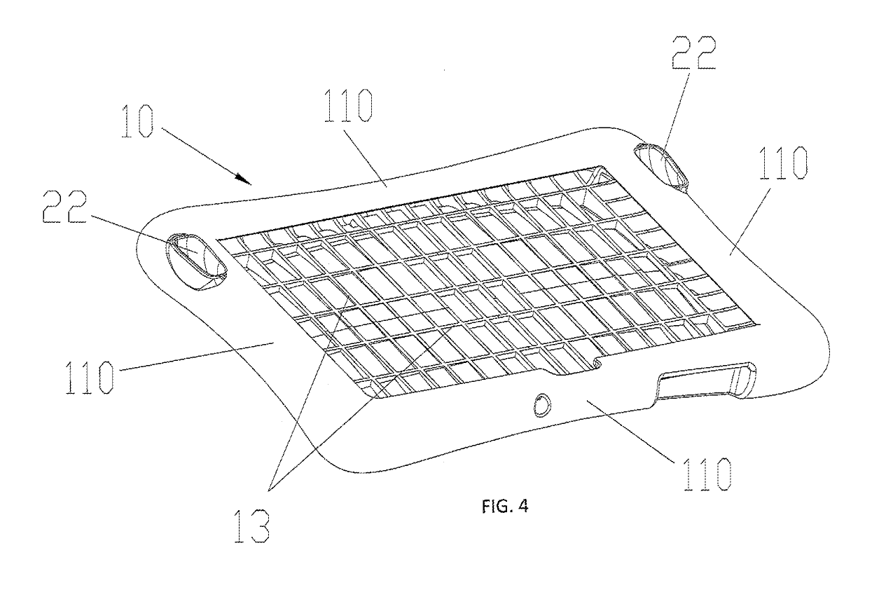

Referring to FIGS. 4, 5, and 6, another embodiment of the digital product protective cover with speakerphone is depicted.

In this embodiment, protective cover main body 10 to the left and right side of card slot includes an amplification mechanism. Sound inlet 21 and sound outlet 22 of each amplification mechanism is located at both ends of the card slot. In particular, sound inlet 21 is located on top of the card slot which is located against the external speaker of the digital product.

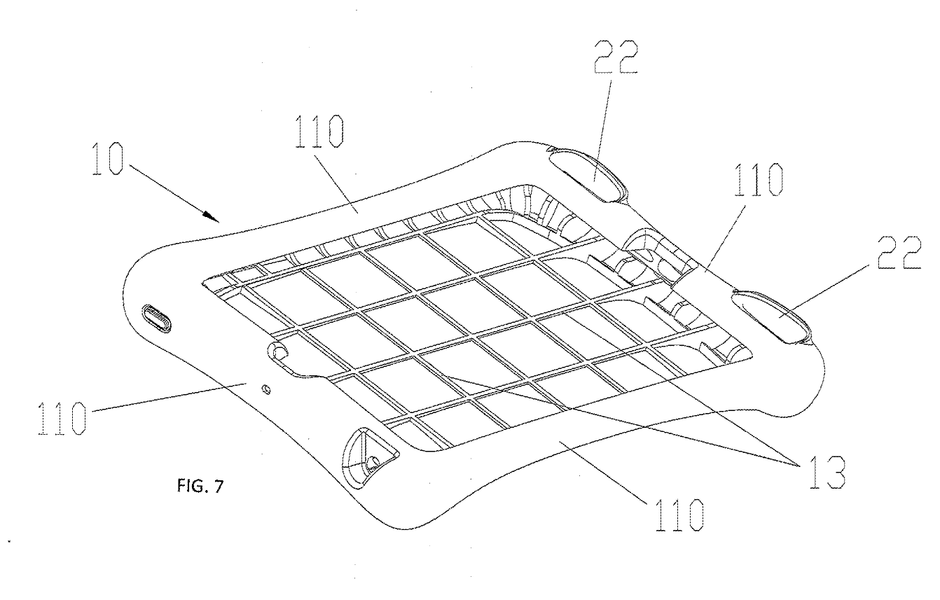

Referring to FIGS. 7, 8, and 9, another embodiment of the digital product protective cover with speakerphone is shown.

In this embodiment, the upper and lower halves of the card slot symmetrically have two amplification mechanisms. In particular, sound inlet 21 of each amplification mechanism is located in the middle of the card slot, while sound outlet 22 is located on one end of the card slot.

The level of the amplification mechanism depends on the level of the external speakerphone. The location of sound inlet 21 and sound outlet 22 is based on the position of the external speakerphone. Therefore, the present invention can be applied to various brands and models of digital products in the market.

The present invention for a digital product protective cover with speakerphone includes sound inlet 21 and sound outlet 22, which is staggered in the longitudinal direction of the card slot to extend the sound signal transmission distance in sound tube 23. This enhances the amplification effect, thereby improving the user experience. Moreover, bottom board 11 includes reinforced ribs 13, which increases the strength of the protective cover. This increased strength provides greater protection for the digital products housed in the protective cover.

Sound tube 23 cross section from sound inlet 21 to sound outlet 22 gradually increases. The surface of bottom board 11 has reinforced ribs 13, which extend to the internal surface of the card slot. Sound inlet 21 and sound outlet 22 is located at both ends of the card slot. The protective cover main body to the left and right side of card slot includes an amplification mechanism. Sound inlet 21 is located in the middle of the card slot and sound outlet 22 is located on one end of the card slot. The upper and lower halves symmetrically have two amplification mechanisms.

As mentioned above, the present invention includes a dislocation position setting of sound inlet 21 and sound outlet 22 to extend the length of sound tube 23. This enhances the amplification effect, and, in turn, improves the user experience.

Technologists in this field can make appropriate changes and deformations according to the above technical solutions and ideas, and all these changes and deformations of the utility model should fall within the scope of the claims.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What I claim is:

1. A digital product protective cover with speakerphone, comprising:
a protective cover main body, the main body further comprising a bottom board and surrounding curved walls;
at least one card slot located between the bottom board and curved walls, wherein each card slot is inter-connected;
each card slot includes at least one amplification mechanism;
the amplification mechanism further comprising:
a sound inlet;
a sound outlet; and,
a sound tube, which connects the sound inlet and sound outlet;
the sound inlet is located at the bottom of the card slot, which is in proximity to an external speaker of the digital product;
the sound inlet and sound outlet are staggered in the longitudinal direction of the card slot; and
the sound inlet and sound outlet are staggered in such a position to extend the length of the sound tube.

2. The digital product protective cover with speakerphone as recited in claim 1, wherein the cross section of the sound tube from the sound inlet to the sound outlet gradually increases.

3. The digital product protective cover with speakerphone as recited in claim 2, wherein the bottom board surface includes reinforced ribs that extend to the internal surface of the card slot.

4. The digital product protective cover with speakerphone as recited in claim 1, wherein the sound inlet and the sound outlet are located at ends of the card slot.

5. The digital product protective cover with speakerphone as recited in claim 4, wherein at least one side of the card slot on the protective cover main body includes an amplification mechanism.

6. The digital product protective cover with speakerphone as recited in claim 1, wherein the sound inlet is centered on the card slot, and the sound outlet is located on an end of the card slot.

7. The digital product protective cover with speakerphone as recited in claim 6, wherein the upper and lower portions of the card slot have at least two amplification mechanisms.

8. The digital product protective cover with speakerphone as recited in claim 7, wherein the amplification mechanisms are symmetrical.
